(19) United States
(12) Patent Application Publication
(10) Pub. No.: US 2013/0187380 A1
(43) Pub. Date: Jul. 25, 2013

(54) Push-on Tubing Coupler with Triple Seal and Adapter

(71) Applicant: Brit Ryan Leggett, Oklahoma City, OK (US)

(72) Inventor: Brit Ryan Leggett, Oklahoma City, OK (US)

(21) Appl. No.: 13/353,699

(22) Filed: Jan. 19, 2012

(51) Int. Cl. F16L 33/18

(52) U.S. Cl. 285/351

(57) ABSTRACT

A press-on fitting for tubing, piping and conduit is provided with an abutment seal to enhance liquid-tight and gas-tight performance, unitary seals to facilitate removal and installation of the seals, and a color-coded hand-manipulable retention cap to allow for tool-less removal and replacement of the collet to allow for ease of withdrawal of an installed tubing, pipe, or conduit, and to allow for color coding of the retention cap to indicate contents, pressure, safety, temperature, etc.

### CROSS-REFERENCE TO RELATED APPLICATIONS

None.

### FEDERALLY SPONSORED RESEARCH AND DEVELOPMENT STATEMENT

Not applicable.

### MICROFICHE APPENDIX

Not applicable.

### INCORPORATION BY REFERENCE

None.

### BACKGROUND OF THE INVENTION

1. Field of the Invention

This invention relates to structures and mechanisms for providing push-on fittings to tubing and pipes.

2. Background of the Invention

There are a wide variety of plumbing fittings which provide the ability to connect a fitting to one or more tubing or pipe pieces. These fittings include, but are not limited to, shut-off valves, check valves, couplers, union connectors, elbows, adapters, reducers, tees, swivels, dividers, end stops, and the like. Some of these fittings attach to and retain the end of a section of tubing or pipe using a variety of methods, including sweating, soldering, gluing, and threading.

However, there is a species of fittings which growing rapidly in use referred to as “press-on” or “push-on” fittings which require few or no tools to attach to tubing or pipe, many of which provide suitable seals for high pressure applications, caustic and acidic applications, potable water applications, etc. This fittings are widely in use in the manufactured home industry, recreational vehicle industry, instrumentation and industrial machinery industry, as well as others. Such fittings may be applied to a wide variety of tubing and pipe, including polyvinyl chloride (PVC), chlorinate PVC (CPVC), flexible PVC, low density polyethylene (LLDPE) tubing. nylon, cross-linked polypropylene (PEX or XPLE), polyurethane, and soft metals (copper, aluminum, etc.). Well-known suppliers of such fittings include G. A. Murdock, Inc., John Guest USA Inc., and Sea Tech, Inc., as well as others.

Turning to FIG. 2, a cross-sectional diagram of such a press fit coupler which is representative of those known in the art is shown. While different manufacturers may use different terminology, many rely on a similar concept of a fitting which slidably receives an end (204) of a section of tubing, conduit or piping (201). The section of tubing, conduit or piping is generally hollow along an axial path (299, 299′), and is typically round or cylindrical in shape about the axis. For the purposes of this disclosure, we will refer to tubing, conduit, and piping collectively as tubing.

A fitting housing (202) provides at least one orifice or channel (207) through which the end (204) of the tubing is received in an advancing direction along the axis (299) of the tubing. The housing typically provides a collet (203) or similar device through which the tubing is advanced during installation or connection, and further advancement of the tubing engages one or more O-rings (206) around the periphery of the outer surface of the tubing (201). Still further advancement along the axis (299) will cause the tubing to reach a shoulder (208) formed in the housing in order to stop the advancement of the tubing and allow the technician to know that the tubing is fully inserted into the fitting.

In this exemplary depiction, the O-ring (206) is disposed in a groove or seat (205) in order to retain it in position when no tubing is engaged by the fitting. The channel (207) provides a mechanical means for aligning the hollow interior of the tubing with the fittings own conductive space (209), which may lead to other portions of the fitting, such as through a valve and to another end of the fitting, directly to another fitting (coupler), to two or more other fittings (tee or divider), to a smaller or larger coupler (reducer), etc.

Typically, for a press-on or press-on fitting, the collet is associated with or provide with some sort of mechanical retention means which engages the outer surface of the tubing during advancement of the tubing into the fitting and allows further advancement somewhat freely, usually with a nominal amount of advancing force. The retention means, however, provides a great deal of resistance to the tubing moving in the reverse (withdrawal) direction (299′). For example, some retention means comprise a set of teeth (210) which are slanted towards the shoulder (208) so that as the outer surface of the tubing passes in an advancing direction over the teeth, they merely slide along the outer surface. However, when the tubing is, pulled in the withdrawal direction (299′), the teeth engage the surface and are pulled in a direction more perpendicular to the walls of the housing (202) such that they bite into the outer surface in a manner which increases proportionally to the amount of withdrawal force. Soft tubing materials allow this biting action to work very well. Alternative retention means, such as frictional and compression means, are also provided in some press-on fittings.

In many models, the collet or a special tool allows for the disengagement of the retention means under the control of a technician, such as by pressing the collet in the advancing direction or un-threading and removing the collet.

### SUMMARY OF THE INVENTION

A press-on fitting for tubing, piping and conduit is provided with an abutment seal to enhance liquid-tight and gas-tight performance, unitary seals to facilitate removal and installation of the seals, and a color-coded hand-manipulable collet to allow for tool-less removal and replacement of the collet to allow for ease of withdrawal of an installed tubing, pipe, or conduit, and to allow for color coding of the collets to indicate contents, pressure, safety, temperature, etc.

### BRIEF DESCRIPTION OF THE DRAWINGS

The following detailed description when taken in conjunction with the figures presented herein provide a complete disclosure of the invention.

FIG. 1a illustrates a cross-sectional view of an improved press-on fitting according to the present invention.

FIG. 1b depicts the embodiment of FIG. 1a, further enhanced by the provision of a unitary triple seal.

FIG. 1c shows more detail of the unitary triple seal of FIG. 1b.

FIGS. 1d and 1e provide more details of a hand manipulable retention cap and insert for non-press-on fittings.

FIG. 1f depicts usage of two unitary triple seal units to provide a liner configuration.

FIG. 2 provides a cross-sectional illustration of a press-on fitting representative of those currently available on the market.

### DESCRIPTION OF THE INVENTION

The present inventor has recognized a problem in the art not yet fully satisfied by available devices and methods for press-on tool-less installation of fittings to tubing, piping and conduit. Due to the mechanical nature of these types of fittings, maintaining a liquid-tight or gas-tight seal is a challenge. To address this challenge, some suppliers have provided two O-rings instead of just one in their fittings. While this is helpful, it is still insufficient to provide a reliable tight connection which is durable.

Applicant has also realize that there is a need in the art for the O-rings to be removable and replaceable so that they can be repaired if damage or aged, or replaced with units which are suitable for the type of material being conducted through the fitting.

Applicant has further realized that there is a need in the art for providing a color-coding scheme to such fittings in order to allow visual determination of the contents or branch of tubing to which the fitting is installed. For example, in hospital instruments, one color may be used to indicate an oxygen line, while another color may be used to indicate a line carrying potable water. In the housing an recreational vehicle market, different colors can be used to indicate fresh water, gray water and black water. In automotive and industrial applications, different colors can be used to indicate fuels, solvents, coolants, chemicals, and by-products.

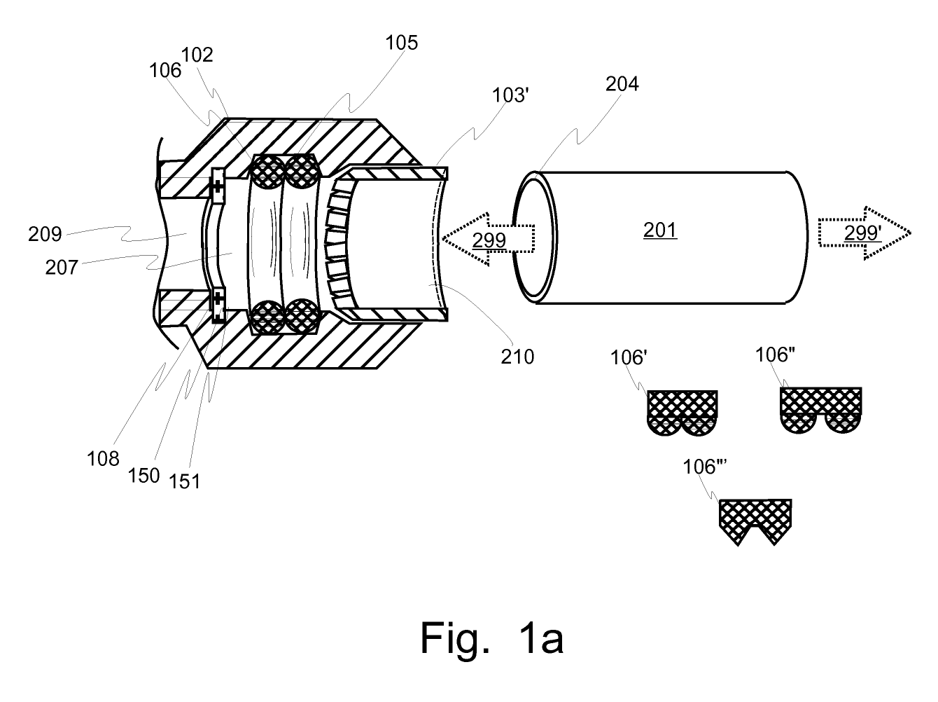

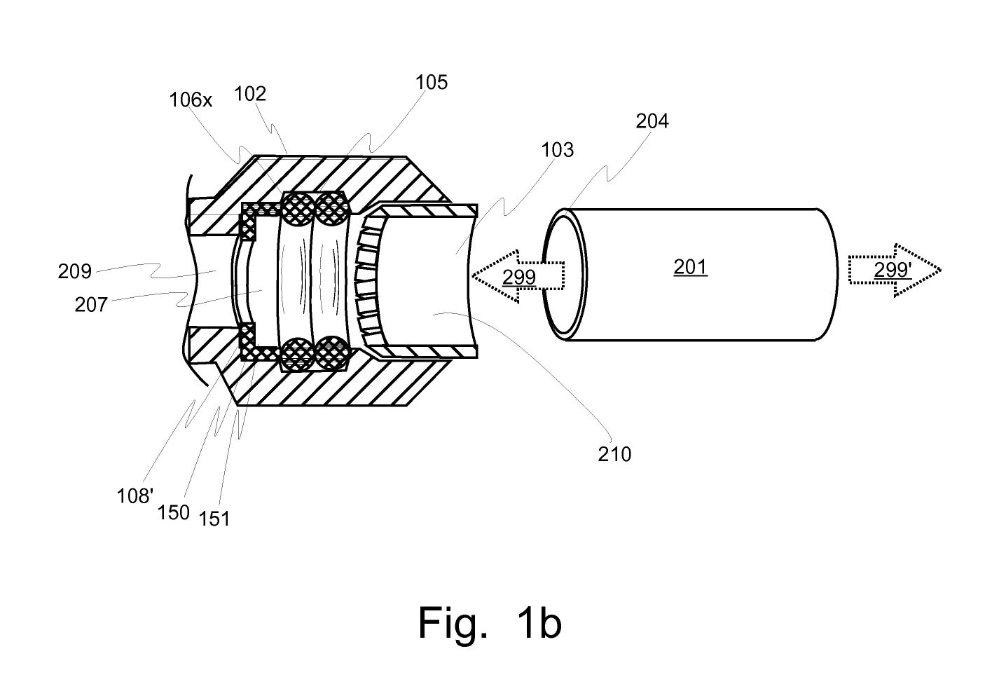

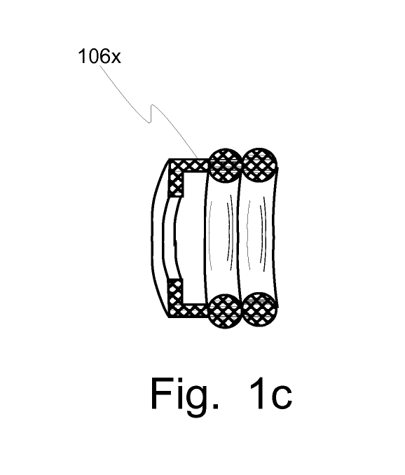

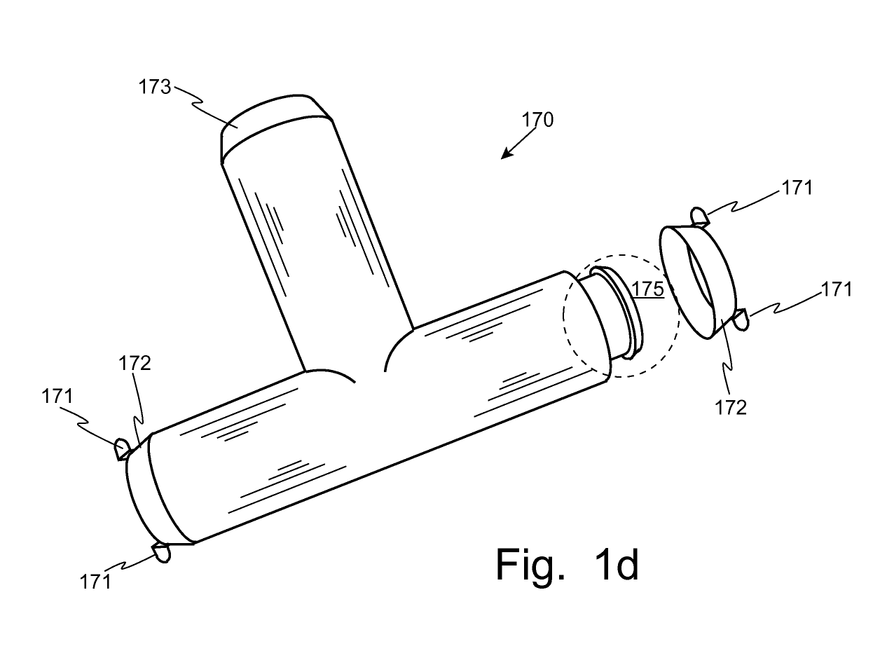

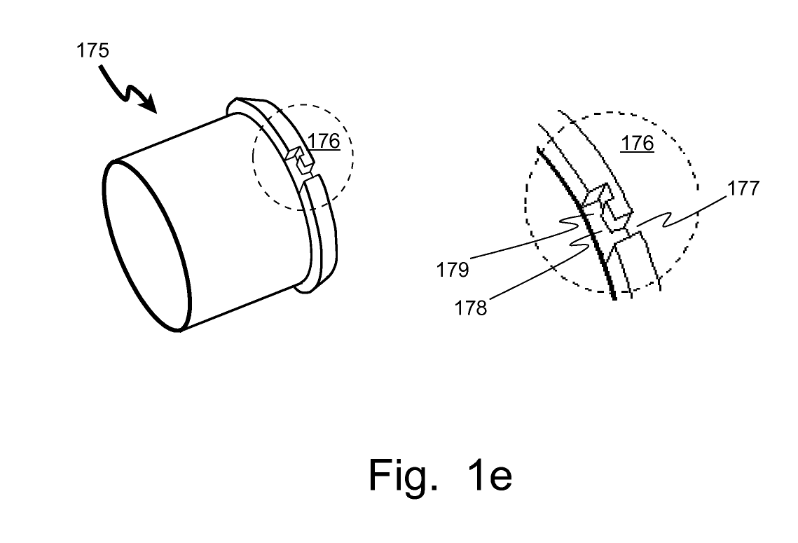

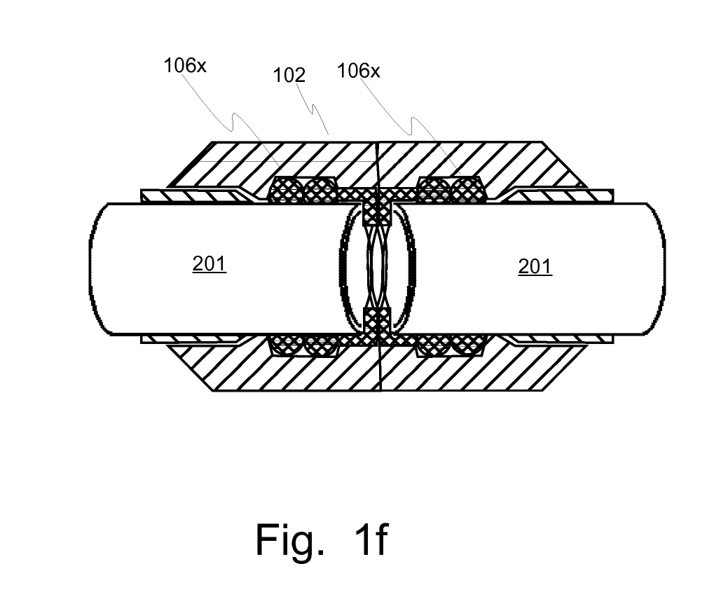

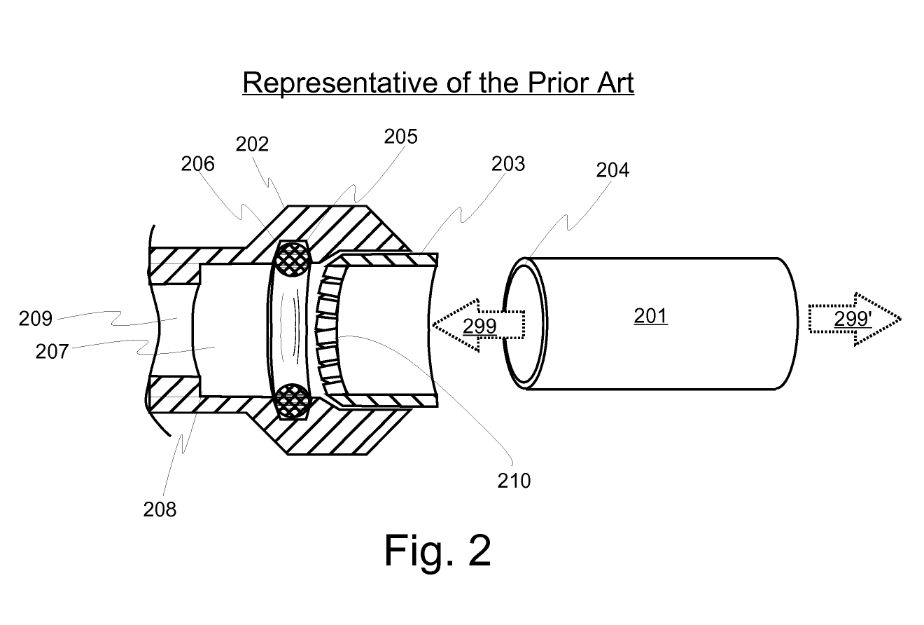

Unitary Double and Triple Seals. Turning the FIG. 1a, an cross-section of an exemplary embodiment according to the present invention is shown which provides a combination of useful improvements and features, compatible with many of the current press-on fittings currently offered in the market. Certain changes to the machining, molding or fabrication may be made to such existing devices to realize the improved press-on fittings according to the invention. In this exemplary embodiment, the single O-ring or pair of separate O-rings is replaced with a unitary, double-seal (106), disposed in a single seat (105). This allows for quicker removal and replacement of a double seal than allowed in the devices currently on the market which employ two separate O-rings which must be individually removed and individually replaced. This is an especially significant improvement in applications where the currently installed double-seal is incompatible with the gas or liquid to be conducted by the fitting and must be replaced. In fittings with two separate O-rings, if both are not suitably removed and replaced with a compatible O-ring (e.g. one is not replaced), then the incompatible O-ring may contaminate the gas or liquid, or may fail due to adverse reaction to the gas or liquid. If the technician is unaware that there are two separate O-rings, this error may happen quite innocently and may have disastrous effects at an indeterminate time in the future. By unifying the dual-seal into a single device (106), such as shown in FIG. 1a, the chances of this error are essentially halved. Exemplary alternative cross-sectional shapes for such a unitary double-seal according to the invention are shown (106′, 106″, 106″′), as well.

Also in this exemplary embodiment of an improved press-on fitting is a third seal (150), such as a disc-shaped washer made of a compressible material suitable for the intended application. This third seal (150) provides a surface (151) disposed towards the receiving orifice of the housing such that when the section of tubing (201) is fully received into the housing, the tubing's end surface (204) is contacted in abutment to the third seal's surface (151), thereby providing a third seal. As the technician presses the tubing further in the advancement direction (299), the third seal is compressed between the end of the tubing (204) and the shoulder (108) of the housing, increasing the seal strength. The retention means will retain the pressure between the end of the tubing (204) and the abutment surface (151) of the third seal. The third seal may retained in place by being disposed into a third seal groove or seat formed in the housing. An advantage of this third seal is that it provides a different sealing mode from the O-rings, whereas the O-rings contact the outer surface of the tubing, the abutment seal (150) contacts the end of the tubing. If the tubing is out-of-round, becomes soft, or swivels excessively to cause wearing down of the outer tube surface, the abutment seal will not be adversely effected like the O-ring seals, and may provide a critical role in maintaining a gas- or liquid-tight fitting.

Turning now to FIG. 1b, another exemplary embodiment according to the present invention is shown, in which the abutment seal is unitized (106x) with the double O-ring seal portion, to provide a single, unitary triple-seal which can be easily removed and replaced for repairs or exchange. FIG. 1c depicts a cross-section of such a unitary triple-seal (106x′) component in more detail.

The aforementioned seals may be fabricated of thermoplastic vulcanizate (TPV), such as Santoprene™ by ExxonMobil™, which is a high-performance elastomers having the beneficial attributes of vulcanized rubber, e.g. flexibility and low compression set, and processing ease of thermoplastics. Seals may be produced using other suitable materials, such as natural and synthetic elastomers such as but not limited to rubber, butyl rubber and neoprene.

Finger-operable, Color-coded Retention Cap. Referring now to FIG. 1d, a finger-operable retention cap (172) for a tee fitting (170) is shown having finger-manipulable tabs (171) to allow its removal and installation without the need for tools. Traditional retention caps (173) do not provide such tabs, but instead typically rely upon crimped or folded metal to hold the cap onto the housing, which in turn retains the components inside the housing. Such traditional retention caps may not be serviceable, or if they are, they require the use of tools to remove and re-install the cap. According to at least one embodiment of the present invention, the finger-operable retention cap (172) is received and held in place on the housing of the fitting using tabs and grooves which mate between the fitting and the retention cap, for example, locking in place with a partial twist of the retention cap, and releasing for removal with a reverse partial twist of the cap.

This improvement to the fitting has several advantages. Firstly, it allows for tool-less removal of tubing which has been installed into the fitting for disassembly of the plumbing. Secondly, when multiple collets are provided of varying external colors, it allows the technician to implement a color-coding scheme by installing colored collets according to the scheme, such as contents of the tubing, pressure level, danger level, temperature, etc.

Retention Cap on Non-Press-on Fittings. Non-press-on fittings, such as glue-on polyvinyl chloride (PVC) fittings, are very common in plumbing and gas conduit applications, but they are not compatible with press-on fittings and tubing. An insert (175), shown in greater detail in FIG. 1e, is provided in one embodiment according to the present invention for slidably installing in a non-press-on fitting, such as into a PVC tee fitting. The insert (175) may be retained by ordinary means, such as through gluing or sweating. The insert provides a retention lip about its exposed edge, with a locking groove (176) as shown in greater &tail in the inset diagram. This exemplary locking groove provides a gate opening (177) for receiving a tab (not shown) on the retention cap (172). After the tab is passed through the gate opening, the retention cap (172) may be rotated so that the tab passes along a pathway (178), eventually with the tab coming to rest in a lock notch (179), whereby the retention cap is held in place. To remove the retention cap (172), one must only press slightly on the retention cap, rotate it in the opposite direction of installation until the tab reaches the gate opening, and the withdraw the retention cap from the insert (175).

Two Unitary Seals Employed as Liner. Some housings and fittings may contain materials which are unsuitable for contacting the liquid or gas which is being conducted through the fitting. For example, some metal-based fittings may contain a level of lead which might be undesirable to contact the conducted fluid or gas. Certain standards and regulations set forth limits for such contaminants which may leach into or otherwise interact with the gas or liquid being conducted through a fitting, such as ANSI/NSF Standard 14, ANSI/NSF Standard 61, as well as the U.S. Safe Drinking Water Act of 1996.

With conventional press-on fittings, the interior channel of conduction allows the gas or liquid to come in contact with housing or fitting material. However, in another manner of usages and another exemplary embodiment according to the present invention, two of the unitary seals (106x) may be used to splice two tubes, pipes or conduits (201) together as shown in FIG. 1f. With the abutment seals coming directly in contact with each other, the conducted fluid or gas may be prevented from touching or interacting with the materials of the housing. In such an arrangement, the two unitary seal units also act as a liner for the interior of the housing, thereby

### SUMMARY

It will be appreciated by those skilled in the art that the aforementioned example embodiments do not represent the full scope and range of possible embodiments according to the present invention. A wide range of construction and manufacturing techniques may be employed, as well as materials and parts designs, to make the improved press-on fitting, such as fabricating the housing and components from plastics and metals through machining, molding, and casting. Seals may be produced using known suitable materials, such as natural and synthetic elastomers such as but not limited to rubber, butyl rubber and neoprene. For these reasons, the scope of the present invention should be determined by the following claims.

What is claimed is:

1. An apparatus for a press-on plumbing fitting comprising:
two circumferential seals in a unitary configuration, disposable into a passageway of a plumbing fitting housing so as to engage an outer circumferential surface of a received tube, pipe or conduit in at least two places, thereby provide a first and a second seal to retain conducted gas, liquid or flowable material in the tube, pipe and housing; and
an abutment seal disposable within a passage way of the plumbing fitting housing so as to contact an end surface off the received tube, pipe or conduit, and to contact a shoulder portion of the plumbing fitting housing, thereby providing a third seal to retain conducted gas, liquid or flowable material in the tube, pipe and housing.

2. The apparatus as set forth in claim 1 further comprising a press-on plumbing fitting, wherein the circumferential seals and the abutment seal are disposed in a press-on fitting.

3. The apparatus as set forth in claim 1 wherein the two circumferential seals and the abutment seal are provided in a unitary configuration, thereby allowing for installation into a fitting housing in a single operation.

4. The apparatus as set forth in claim 1 wherein the two circumferential seals and the abutment seal are provided in a unitary configuration, thereby allowing for removal from a fitting housing in a single operation.

5. The apparatus as set forth in claim 1 wherein the circumferential seals are comprised of a material selected from the group consisting of thermoplastic vulcanizate, natural rubber, a synthetic elastomers, butyl rubber, and neoprene.

6. The apparatus as set forth in claim 1 wherein the abutment seal is comprised of a material selected from the group consisting of thermoplastic vulcanizate, natural rubber, a synthetic elastomers, butyl rubber, and neoprene.

7. The apparatus as set forth in claim 4 wherein the unitary circumferential and abutment seals are comprised of a material selected from the group consisting of thermoplastic vulcanizate, natural rubber, a synthetic elastomers, butyl rubber, and neoprene.

8. The apparatus as set forth in claim 2 further comprising:
two additional circumferential seals in a unitary configuration disposed into the passageway of the plumbing fitting housing so as to engage an outer circumferential surface of a second received tube, pipe or conduit in at least two places, thereby providing a fourth and fifth seals to retain conducted gas, liquid or flowable material in the tube, pipe and housing; and
an additional abutment seal disposed within the passage way of the plumbing fitting housing so as to contact an end surface off the second received tube, pipe or conduit, thereby providing a third seal to retain conducted gas, liquid or flowable material in the tube, pipe and housing.

9. The apparatus as set forth in claim 8 wherein the two abutment seals also contact each other to form a sixth seal, yielding a liner that isolates the conducted gas, liquid or flowable material from contact or interaction with the fitting housing.

10. An apparatus for adapting a non-press-on plumbing fitting to receive a tubing or conduit through press-fit manipulation, the apparatus comprising:
an adapter insert having a first end with an outer diameter suitable for a close fit to the inner diameter of a non-press-on plumbing fitting, a second end with a means for receiving and latching a retention cap, and a passageway through the adapter insert for conducting a fluid, gas, or flowable material through between the second end, through the first end, and into or out of the non-press-on plumbing fitting; and
a retention cap configured to install onto and latch onto the second end of the adapter insert, and further configured to retain one or more components of a press-on fitting suitable for receiving and holding a tubing, pipe or conduit, the retention cap having a means for gripping by hand and operating the retention cap, thereby allowing installation and removal from the adapter insert without need for tools.

11. The apparatus as set forth in claim 10 further comprising a non-press-on fitting, wherein the adapter insert is received and affixed into the non-press-on-fitting.

12. The apparatus as set forth in claim 11 wherein the adapter insert is affixed using a affixation selected from the group consisting of gluing, sweating, soldering, welding, and threading.

13. The apparatus as set forth in claim 11 further comprising one or more components of a press-on fitting retained in the adapter by the retention cap, thereby adapting the non-press-on fitting to press-on reception of a tube, a pipe or a conduit.

14. The apparatus as set forth in claim 13 wherein the one or more components of a press-on fitting comprise one or more teeth which compress around a received pipe, tube or conduit to prevent withdrawal of the pipe, tube or conduit.

15. The apparatus of claim 11 wherein the non-press-on fitting is a fitting selected from the group consisting of a shut-off valve, a check valve, a coupler, a union connector, an elbow, an adapters, a reducer, a tee, a swivels, a divider, and an end stop.

16. The apparatus of claim 10 wherein the retention cap is provided in two or more external colors, thereby allowing an installer to establish or follow a color-coding scheme to indicate one or more factors selected from the group consisting of identification of the contents of the fitting, temperature of the contents of the fitting, potability of the contents of the fitting, and pressure of the contents of the fitting.
